(19) United States
(12) Patent Application Publication
(10) Pub. No.: US 2023/0047833 A1
(43) Pub. Date: Feb. 16, 2023

(54) BELLOWS FOR A GANGWAY BETWEEN TWO VEHICLES MOVABLY CONNECTED TO ONE ANOTHER OR FOR A JETWAY

(71) Applicant: HÜBNER GmbH & Co. KG, Kassel (DE)

(72) Inventor: Andreas Kunze, Melsungen (DE)

(21) Appl. No.: 17/819,109

(22) Filed: Aug. 11, 2022

(30) Foreign Application Priority Data
Aug. 12, 2021 (EP) 21190968.4

(51) Int. Cl. B60D 5/00

(52) U.S. Cl. CPC B60D 5/003

(57) ABSTRACT

A bellows as gangway protection between two movably connected car bodies or a jetway has a roof and two side parts facing one another. At least the two side parts have a multiplicity of folds or corrugations formed of a bendable sheet material. Each fold or corrugation has a narrow and a longitudinal side. Two folds or corrugations abutting one another are joined along their longitudinal sides. At least one fold or corrugation has at least one reinforcing section and at least two normal sections. The reinforcing section has a thickness greater than the normal sections. The reinforcing section has a narrow and a longitudinal side. The longitudinal side primarily extends in the direction of the longitudinal side of the fold or corrugation. An extension of the narrow side of the reinforcing section is a maximum of 75% of an extension of the narrow side of the fold or corrugation.

### CROSS REFERENCE TO RELATED APPLICATIONS

This application claims priority to European patent application 21190968.4 filed Aug. 12, 2021, which is hereby incorporated by reference in its entirety.

### FIELD OF THE INVENTION

The present invention concerns a bellows as gangway protection for a gangway between two car bodies that are movably connected with one another on a multi-section vehicle or between a jetway (passenger bridge) and an aircraft, whereby the bellows exhibits a roof and side parts arranged facing one another; whereby at least the two side parts each exhibit a multiple number of folds or corrugations that are made of a material that can be folded, whereby each of the folds or corrugations exhibits a narrow side and a longitudinal side, whereby two folds or corrugations that are arranged next to each other are joined to one another along their longitudinal sides.

### BACKGROUND OF THE INVENTION

In the case of means of public transport such as buses and trains, but also regarding jetways, it is usual to provide a gangway for the passengers between two sections of a vehicle or a jetway and an aircraft for protection against the weather, drafts and other environmental influences. The bellows that are required for this enclose the gangway, at least in the area of the roof and the side parts that are arranged facing one another.

The individual bellows thus typically has, or at least in the area of the side parts, a multiplicity of folds or corrugations made out of a material that can be folded so that the movements of the bellows between the car bodies or the jetway and the aircraft can be compensated for.

While a conventional bellows succeeds in keeping out environmental influences such as the weather, providing effective acoustic protection in the area of the gangway that is protected by the bellows represents a challenge, then and now.

### SUMMARY OF THE INVENTION

As opposed to the current state of the art, it is the task of the present invention a bellows for a bellows of the type described above that will provide effective and efficient acoustic insulation.

In order to accomplish this task, a bellows with the features of an embodiment of the present application is provided by way of invention. To do this, in the bellows of the type described above at least one of the folds or corrugations has a reinforcing section and at least two normal sections and whereby the reinforcing section is of a thickness that is greater than one thickness of two of the normal sections, whereby the reinforcing section has a narrow side and a longitudinal side, whereby the longitudinal side of the reinforcing section stretches primarily in the direction of the longitudinal side of the fold or corrugation and whereby an extension of the narrow side of the reinforcing section is at most 75% of the extension of the narrow side of the fold or corrugation.

The present invention has succeeded in providing effective and optimized acoustic protection, i.e. with regard to the desired effect and the associated material and/or manufacturing costs. What is mean by acoustic protection within the meaning of the present application is protection of the defined inner area of the bellows with regard to sound coming from a source outside the bellows. Surprisingly, it was shown that it is not necessary for an effective form of acoustic protection to make one fold or corrugation of the bellows out of a thicker materials or to line it completely with a second material so that a structure that is thicker overall is produced. It was do7und that it was sufficient to thicken in sections the fold or corrugation in a direction parallel to the narrow side of the fold or corrugation.

Within the meaning of the present application, what is meant by an inner side is the side of the side part, the roof or the floor of the bellows that points inwards to the defined interior of the bellows when forming a gangway when the bellows is in an installed state, while an outer side designates the side exposed to the environment outside the bellows.

Within the meaning of the present application, what is meant by a fold or a corrugation is a section or segment, e.g. of the relevant side part of the bellows that describes in a cross section parallel to the narrow side a path from the inner side of the bellows in the direction of the outer side to the outside and back again or vice versa.

In an embodiment of the invention the bellows constitute a folding bellows, whereby the folds are arranged parallel to the narrow side in a zigzag way in a cross sectional plane. In a folding bellows of this type each fold has two flat sections that run approximately straight. The folds of a folding bellows run in a somewhat V-shaped way when seen as a cross section that is parallel to the fold.

In an embodiment of the invention a fold is produced out of two flexible sheets of material joined to one another, which for preference form straight flat sections. Thus in an embodiment of the invention the two sheets of material are joined together at the peak of the fold. A join of this type is formed in an embodiment of the invention by a seam, gluing, welding and/or a clamping profile, for example, made of steel of aluminum. Each fold is likewise connected with at least one neighboring fold. A join of this type is formed in an embodiment by a seam, gluing, welding and/or a clamping profile, for example, made of steel or aluminum.

In an embodiment of the invention the bellows constitute a form of bellows whereby the folds are arranged parallel to the narrow side in a curved way when seen in a cross section. The folds of a bellows run in a somewhat V-shaped way when seen as a cross section that is parallel to the narrow side of the fold.

A corrugation within the meaning of the present invention is formed by a material section that is either curved from the inner side to the outside and then brought back to the inner side or vice versa.

In an embodiment of the invention the corrugation is produced primarily out of a rectangular sheet of flexible material with a longitudinal side and a narrow side. Here the individual corrugation can be one part or multiple parts, whereby multiple sections of flexible sheet material can be produced by, for example, by joining them using welding, gluing or sewing together.

Each of the two corrugations arranged next to one another are joined together on their longitudinal sides. A join of this type is formed in an embodiment by a seam, gluing, welding and/or a clamping profile, for example, made of steel of aluminum. In an embodiment of the invention multiple corrugations can be produced from a single sheet of flexible material.

The narrow side of the fold or corrugation when in an installed state primarily runs parallel to the bellows to the bridge between the car bodies or the jetway sections. In the installed state of the bellows the narrow sides primarily runs horizontally. On the other hand, in the installed state of the bellows the longitudinal side of the fold or corrugation and the longitudinal side of the reinforcing section primarily runs vertically and/or horizontally to the bridge.

When the narrow side of the fold or corrugation is extended then in this application the geometrical length of the whole is exactly one fold or corrugation of the materials that is made of, seen parallel to the narrow side in a cross section.

A reinforcing section can be made up of one or more single sections in the direction of the longitudinal or narrow sides. These sections can be arranged with or without spacing from one another.

In an embodiment of the invention the roof also comprises a multiplicity of folds or corrugations made of a bendable material, as described previously for the side parts.

In an embodiment of the invention the side parts have a straight run in the longitudinal direction, at least in sections. In an embodiment the material of the bellow of the side part follows a curved run in a gangway area between the side part and the roof.

It is to be understood that in an embodiment of the invention that at least one of the folds or corrugations of the roof shall have at least one reinforcing section and at least two normal sections.

In an embodiment of the invention the bellows shall also have a floor in addition to the roof and the two side parts arranged facing one another. In an installed state of the bellows the floor extends under the bridge system for the gangway between the car bodies or the jetway sections.

In an embodiment of the invention the floor shall also have a multiplicity of folds or corrugations made of a bendable material. In an embodiment of the invention that at least one of the folds or corrugations of the floor shall have at least one reinforcing section and at least two normal sections.

In an embodiment of the invention the reinforcing section is in the form of strips, whereby the longitudinal side of the reinforcing sections that are made up of strips are at least half as long, and preferably as long as, a straight section of the fold or corrugation. It was found that optimal noise reduction was achieved if the reinforcing section is approximately as log as and the longitudinal side of the straight section of the fold or corrugation. However, a similarly good level of acoustic insulation and/or damping effect could be achieved if the reinforcing section is made shorter and is made up of a multiplicity of shorter strips arranged one after another in the longitudinal direction.

In an embodiment of the invention the thickness of the reinforcing section is at least 1.25x, and preferably 1.5x, and especially preferably, at least 2x the thickness of the normal section. For example, in an embodiment of the invention the thickness of the material of the fold or corrugation in the normal section is 4 mm, while the total thickness of the material in the reinforcing section is 5.1 mm. It was found that a good acoustic insulating and/or damping effect could be achieved even with a relatively small amount of material.

In an embodiment of the invention the thickness of the reinforcing section is to be a maximum of 4x, preferably a maximum of 3x, of the thickness of the normal section.

In an embodiment of the invention the extension of the narrow side of the reinforcing section is to be a maximum of 60%, preferably a maximum of 50%, and especially preferably a maximum of 25% of the extension of the narrow side of the fold or corrugation.

It was found that also with a material expenditure along the narrow side of a maximum of 60%, preferably a maximum of 50% and especially preferably a maximum of 25% of the extension of the narrow side of the fold or corrugation allowed a considerable amount of acoustic insulation and/or damping to be achieved. It is also evident that, the less the extension of the narrow side of the reinforcing section is, related to the extension of the narrow side of the fold or corrugation, the more efficient is the acoustic insulation and/or damping relating to the expenditure of material.

In an embodiment of the invention the extension of the narrow side of the reinforcing section is to be at least 5%, preferably at least 10% of the extension of the narrow side of the fold or corrugation. It was shown that an extension of the reinforcing section below these specified values no longer justified the cost of the material for the acoustic insulation and/or damping effect that was achieved.

In an embodiment of the invention the width of the narrow side of the reinforcing section is to be at least 10 mm, and preferably at least 20 mm.

In an embodiment of the invention at least one fold or corrugation has at least two, and preferably exactly two, reinforcing strips spaced apart from one another and running along the narrow side of the fold or corrugation. It was found that the acoustic insulation and/or damping effect of the reinforcing section depends not only on its surface extension relative to the extension of the fold or corrugation and its thickness, but also on the arrangement of the reinforcing section along the narrow side of the fold or corrugation.

If the bellows is a folding bellows, then each fold has two surface sections running approximately straight which can be excited by a sound wave acting from outside. It is in just such a configuration that the arrangement of at least two, but preferably exactly two reinforcing sections, in which each of the reinforcing sections is arranged on one of the flat sections of the fold, provides good acoustic insulation and/or damping.

The excitation of the corrugation of a corrugated bellows due to the action of a sound wave is done outside the mechanically very stable peak, i.e. between the peak and the ends of the corrugation along the narrow side. For that reason, in an embodiment of the invention, in which the bellows is a corrugated bellows, then at least two, and preferably exactly two reinforcing sections are arranged along the curved side surfaces of the corrugation, outside its peak.

In an embodiment of the invention the two reinforcing sections are distributed to mirror one another symmetrically via the symmetry plane running along the peak of the fold or corrugation along the narrow side of the fold or corrugation.

In an embodiment of the invention the bellows is a corrugated bellows, whereby the two reinforcing sections cover two lines that are parallel to the longitudinal sides of the corrugation and whereby the lines of the narrow side of the bendable strips of material are divided into three segments with roughly the same extension. Such a configuration is especially advantageous for corrugated bellows, whose individual corrugations exhibit a relatively short extension so that the bellows approximately describe a semicircle.

In a further embodiment of the invention the bellows is a corrugated bellows with a multiplicity of corrugations, whereby the two reinforcing sections cover two imaginary lines that are parallel to the longitudinal sides of the corrugation and whereby in a section plane the first of the two lines is arranged parallel to the narrow side of the corrugation at an angle of+ 45° related to a mirrored symmetry plane of the corrugation and the second one of the two lines is arranged at an angle of -45° related to the mirrored symmetry plane, whereby the peak of the angle is given by an intersection between the mirrored symmetry plane and a straight line that is vertical to the mirrored symmetry plane so that a circle around the peak intersects the straight line and the mirrored symmetry plane within the bendable sheet material of the corrugation, and whereby the circle is determined in a non-extended and in an uncompressed state of the corrugation.

As described above, the excitation of a corrugation of the corrugated bellows due to the action of a sound wave takes places in particular the mechanically very stable peak. It was found that the areas experience the maximum excitation in the case of such a corrugation arranged at an angle of less than 45° if a section of the corrugation that forms an arc of 180° is examined.

Within the meaning of the present application, the non-extended and uncompressed state of the corrugation is the stress-free state in the installed state of the bellows when it is ready for operation.

In an embodiment of the invention the reinforcing section is formed by a thickening of the bendable strip-like material of the fold or corrugation. To put it another way, in such an embodiment a single layer of a flexible strip-like material forms the relevant reinforcing section. Normally an elastomer-coated substrate material is used as the material for the fold or corrugation. In particular, the substrate material can be a fabric. In order to form the thickening, the substrate material in the reinforcing section can exhibit a greater thickness than in the normal sections and/or multiple layers of the substrate material can be used to produce a greater thickness. Alternatively or additionally, the elastomer coating in the area of the thickening can be applied more thickly and/or an additional coat can be applied if, for example, it can likewise be elastomer-based.

In an alternative embodiment the reinforcing section has a strip-like piece of bendable material of the fold or corrugation applied to it and made up of the associated strip of material. In doing so, the connection between the bendable strip-like material of the fold or corrugation and the strips of material in an embodiment can be made by, for example, gluing, sewing or welding or by a combination of those.

It is evident that in an embodiment of the invention that the strips of material defining the reinforcing section likewise are made of a bendable strip-like material.

In an embodiment of the invention the strip of material that defines the reinforcing section follows a curve of the bendable strip-like material of the fold or corrugation. In particular, the strips of material defining the reinforcing section surround the fold or corrugation, which surround both the straight sections, such as the side parts, the roof, and if applicable, the floor, as well as the corners.

In an embodiment of the invention the strip of material is sewn together with the bendable, strip-like material of the fold or corrugation with two seams, whereby the seams preferably run in a direction parallel to the narrow side of the strip of material and preferably with a distance of ate least 5 mm between them, preferably with at least 7 mm between them, and especially preferably with at least 10 mm between them. In an embodiment the two seams primarily extend along the longitudinal direction of the strip of material. In an embodiment of the invention the strip of material is sewn with exactly two seams with the bendable strip-like material of the fold or corrugation.

It was found that two seams running in the longitudinal direction and with the stated minimum spacing between them were easy to produce and thus provide effective acoustic insulation and/or damping. This applies even if in an embodiment the strips of material are not connected flat with respect to the bendable strip-like material of the fold or corrugation, for example, by gluing.

Fundamentally speaking, the reinforcing section can be produced by thickening the material on the outer side or the inner side of the fold or corrugation. In view of the various options for the structuring of the fold or corrugation, and in particular in th case of a corrugation, either the concave or the convex side can be on the inner side. In a preferred embodiment the reinforcing strip is located on the concave side of the corrugation, and in particular, regardless of whether this is on the inner side or the outer side. This arrangement results in especially good acoustic insulation and/or damping. In a further embodiment the reinforcing sections are arranged on an inner side of the bellows. An embodiment of this type reduced the amount of dirt, weather effects and environmentally-determined wear of the reinforcing strip when in operation.

In an embodiment of the invention at least half of the multiplicity of folds or corrugations has at least one reinforcing strip. The arrangement of the reinforcing strips on at least half of the multiplicity of folds or corrugations already provides a noticeable degree of acoustic insulation and/or damping. In an embodiment at least 75% of the multiplicity of folds or corrugations has at least one reinforcing section. In an embodiment each of the folds or corrugations has at least one reinforcing section.

In an embodiment of the invention the bellows has on its facing side a connecting element for the installation of the bellows in a car body of multi-part vehicles or in a jetway. In a further embodiment of the invention the bellows has on its facing side, especially on the facing side with the flange of the facing side opposite to it, a coupling frame to connect the bellows to a second car body, or to a bellows installed on another car body, or to another jetway.

The task described above is resolved in addition by a gangway system with a bellows in an embodiment, as described previously, and a bridge. Such a gangway system is supplied by the manufacturers of railway carriages or buses in the form of a supplied part or system.

The present invention also concerns in an embodiment a vehicle, and in particular a railway carriage or a bus, with a car body to which the bellows is installed on the facing side in accordance with an embodiment, as described above.

In addition, an embodiment of the present invention also comprises a bridging section of a jetway, on the facing side of which a bellows is installed in accordance with an embodiment, as described above.

With regard to advantageous embodiments of the gangway system in accordance with the invention, of a vehicle in accordance with the invention and a jetway in accordance with the invention and their bridging section, the embodiments shall apply in accordance with the bellows that are the subject of the invention.

### BRIEF DESCRIPTION OF THE DRAWINGS

Further advantages, characteristics and application possibilities for the present invention are made clear on the basis of the following description of embodiments and the related figures. The figures designate the same elements with the same reference signs.

FIG. 1 is an isometric illustration of a corrugated bellows;

FIG. 2 is a schematic cross-section view in a section plane that is parallel to the narrow side of the folds of a corrugated bellows as per this invention;

FIG. 3 is a schematic cross-section view in a section plane that is parallel to the narrow side of the corrugations of a corrugated bellows as per this invention;

FIG. 4 is a schematic cross-section view in a section plane that is parallel to the narrow side of the corrugations by a corrugation of a corrugated bellows as per a second embodiment of this invention and

FIG. 5 is a schematic cross-section view in a section plane that is parallel to the narrow side of the corrugations by a corrugation of a corrugated bellows as per a further embodiment of this invention.

### DETAILED DESCRIPTION OF THE INVENTION

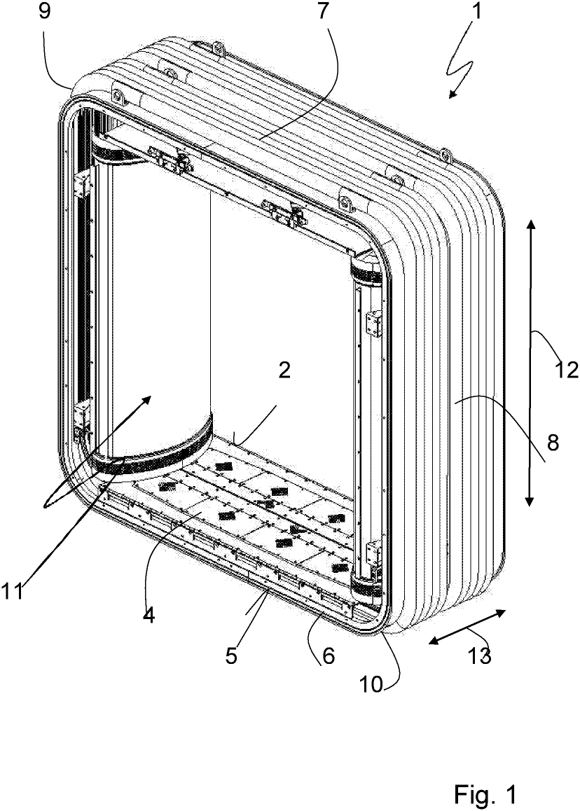

FIG. 1 shows a bellows 1 that is in the form of a corrugated bellows,, as is used for the connection of two railway carriages. The illustration in FIG. 1 is intended to describe in a comprehensible an application of the present invention, whereby the reinforcing sections 14 in FIG. 1 cannot be seen.

Bellows 1 as illustrated in FIG. 1 is connected to a car body 3 of a railway carriage with its facing side 2 turned away. Bellows 1 is used to protect the gangway between car body 3 of the two railway carriages that are coupled together to protect against environmental influences, especially the airstream and the weather. Bellows 1 forms a gangway system together with the bridge 4, which is surrounded by bellows 1. In FIG. 1 at the front facing side 5 the bellows 1 exhibits a screw-on frame 6 to connect the bellows to the car body 3. Bellows 1 comprises a roof 7 and two side parts 8, 9 arranged facing one another. In addition,the illustrated bellows 1 has a floor 10 that passes through underneath the bridge 4. In this way bellows 1 forms a type of frame around the gangway between two car bodies 3 of two railway carriages coupled to one another.

The narrow side of the individual folds or corrugations of the side parts 8, 9 is designated in FIG. 1 with the reference sign 13. The longitudinal side of the corrugations or folds designates the direction designated in FIG. 1 with the reference sign 12.

The individual corrugations 18 of bellows 1 are made up of a bendable strip-like material that is an elastomer-coated fabric in the illustrated embodiment. The folds 18 of the corrugated bellows from FIG. 1 run in a plane that is parallel to the narrow side 13 of the individual folds and are mainly U-shaped. A basically similar setup of a bellows 1 can also be produced as a folding bellows 1, whereby the individual folds 15 of the bellows are than arranged in a plane that is parallel to the narrow side 13 and are mainly U-shaped.

In addition to protection from the airstream and the weather, the bellows 1 serve also to insulate from and/or dampen ambient noises, in general terms this is acoustic protection.

In order to improve this acoustic protection, which is provided solely by the separation of the inside area 11 of bellows 1 from the environment by bellows 1, then in accordance with the invention reinforcing sections 23 are applied to the individual folds 15 or corrugations 18 of a bellows 1, 1. The reinforcing sections 23 support the relevant fold or corrugation in areas with less mechanical stability. The remaining thinner sections of each fold 15 or corrugation 18 constitute the normal sections 24 within the meaning of the present application.

In all the illustrated embodiments each fold 15 or corrugation 18 has exactly two reinforcing sections 23 so that each fold or corrugation has three normal sections 24. Each reinforcing section 23 is made up of a strip of material 14 that is sewed onto the bendable sheet material 16 of the fold 15 or corrugation 18. The strips of material 14 that define the reinforcing sections 23 are arranged on the inner side of the relevant bellows 1, 1'.

The strips of material 14 of the reinforcing sections 23 are likewise made of a bendable material so that they can follow a curve of the bendable sheet material 16 of the fold 15 or corrugation 18. Each of the strips of material 14 is sewn with two seams to the bendable sheet material 16 of the fold 15 or corrugation 18, whereby the seams 17 run in a direction that is parallel to the narrow side 13 of the material section 14 with a distance of 10 mm between them.

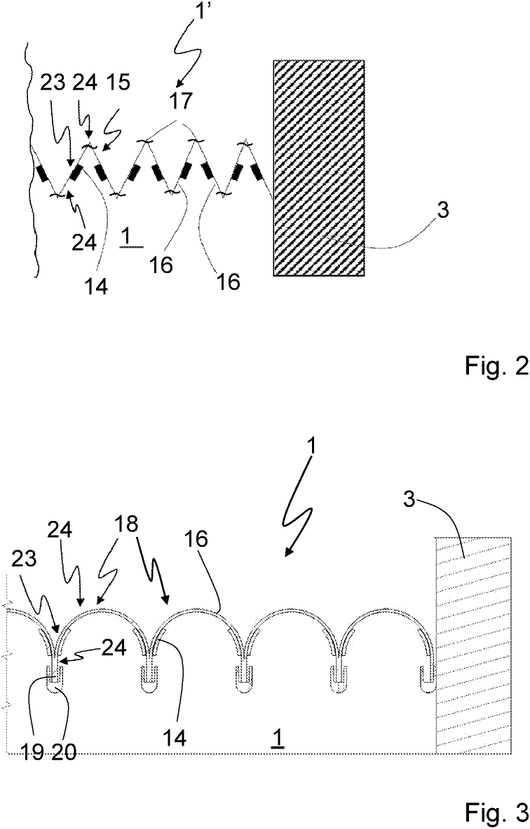

In the following the individual folds 15 or corrugations 18 of a bellows 1, 1’ will be looked at in the following, in accordance with the present invention. FIG. 2 illustrates the formation of the reinforcing sections 23 in a folding bellows 1 in accordance with the invention. On the other hand, FIG. 3 shows the formation of reinforcing sections 23 of this type in a corrugated bellows 1.

The folding bellows 1’ from FIG. 2 exhibits a multiplicity of folds 15, whereby the folds 15 are made out of two flexible sheets of material 16 that are V-shaped in a cross-section plane that is parallel to the narrow side 13 of the folds 15. The individual sheets of material are sewn together at their ends. The corresponding seams and shown schematically in FIG. 2 and designated with reference sign 17. The extension of a fold 15 in a direction that is parallel to the narrow side designates the length of the sheets of material 16 that are joined together as part of a single fold 15. The reinforcing sections 14 are applied such that they reinforce each leg of the relevant fold 15 in the area of its middle. In this area the relevant fold 15 the lowest mechanical stability and thus has the highest probability of causing acoustic excitation. Thus each fold 15 has exactly two reinforcing sections 14.

The individual corrugations 18 of the corrugated bellows 1 from FIG. 3 likewise have exactly two reinforcing sections 14. Thus the corrugations 18 can clearly be seen to be U-shaped in the cross-section profile. Each of the corrugations 18 is made up of a bendable strip of material and extends from the inside area 11 in a curve to the outside and then back inside again. Two adjacent corrugations 18 and their sheets of material 16 are joined to one another at their ends 19. In this connection a clamping profile 20 made of aluminum provides the required stability. The extension of the narrow side 13 of each corrugation 18 is the length of the sheet material 16 in the illustrated cross-section view, which illustrates precisely one corrugation 18.

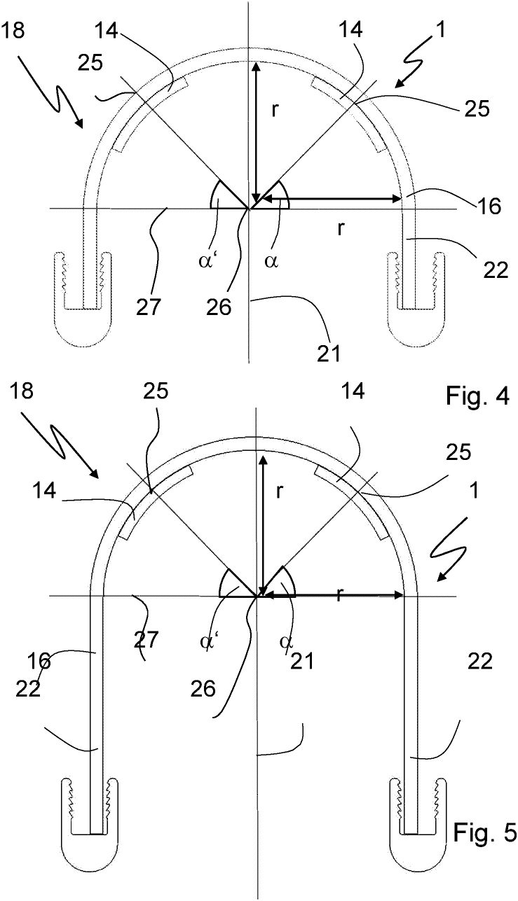

As a result of the arrangements of the reinforcing sections 14 shown in FIGS. 2 and 3, and also FIGS. 4 and 5 described in the following, a considerable reduction of the amount of noise from the environment entering the inside area 11 defined by the bellows 1’ was attained.

The sheet of bendable material 16 of the folds 15 or corrugations 18 had a thickness of 4 mm in all the embodiments shown. The strips of material 14 that define the reinforcing sections 23 are 1.1 mm thick, so that the thickness of the reinforcing sections is a total of 5.1 mm. Thus the thickness of each of the reinforcing sections 23 is 1.275x the thickness of the normal sections 24.

In each of the embodiments shown the two reinforcing sections 23 are mirrored symmetrically in a mirrored symmetry plane 21 of the fold 15 or corrugation 18 along the narrow edge of the fold 15 or corrugation 18.

In all the embodiments shown each fold 15 and each corrugation 18 exhibits exactly two reinforcing segments 23.

FIGS. 4 and 5 show two further embodiments of the corrugated bellows 1 in accordance with the invention, whereby only a single corrugation 18 is shown of these corrugated bellows.

While FIG. 4 shows a corrugation 18 with a relatively small extension, the extension of the corrugation 18 from FIG. 5 is noticeably greater. This means that in the cross-section view from FIG. 4 the corrugation 18 completely follows a curved course, while the corrugation 18 from FIG. 5 exhibits two comparatively long straight sections or legs 22.

It was found that regardless of the extension of the sheet material 16 in the direction parallel the narrow side that the area of the sheet material 16 of the corrugation 18 has the lowest mechanical stability and hence the highest probability for acoustic excitation in a range of ±45° from the arc formed by the sheet material 16.

For that reason both the embodiments of FIGS. 4 and 5 have the two strips of material 14, which define the reinforcing sections 23, arranged in such a way that they cover two imaginary lines 25 running parallel to the longitudinal sides 12 of the corrugation 18. Thus in the illustrated section plane the first of the two lines 25 is arranged at an angle α of + 45° related to the mirrored symmetry plane 21 and the second of the two lines 25 is arranged at an angle α′ of- 45° related to the mirrored symmetry plane 21, whereby the peak 26 of the angles α, α′ is given by the intersection between the mirrored symmetry plane 21 and a straight line 27 that is vertical to the mirrored symmetry plane 21, so that a circle with radius r about the peak 26 intersects the straight line 27 and the symmetry plane 21 within the bendable sheet material 16 of the corrugation 18. Thus the corrugation 18 in both FIGS. 4 and 5 is shown in its non-extended and uncompressed state.

For the purposes of the original publication reference was made to the fact that all the characteristics, in the way that they have been disclosed for an expert in the present description and drawings, even if they were only concretely described in connection with certain other characteristics, both individually and also in any particular combinations with others of the characteristics or groups of characteristics published here that they can be combined with, insofar as that was not expressly excluded or technical circumstances make such combinations impossible or meaningless. A comprehensive and explicit illustration of all possible conceivable combinations has been dispensed with here so as to keep the description short and easy to read.

While the invention has been illustrated and described in detail in the drawings and the preceding description, the illustration and description are only exemplary and are not intended to be a restriction of the protected area in the way that is defined in the claims. The invention is not restricted to the published embodiments.

Variations from the published embodiments will be obvious for an expert from the drawings, the description and the attached claims. In the claims the word “exhibit” does not exclude other elements or steps, and the indefinite article “a” does not exclude a multiple number. The mere fact that certain characteristics are demanded in various requirements does not exclude the possibility of their combination. The reference signs for the claims are not intended as a restriction of the area of protection.

### LIST OF REFERENCE SIGNS

1 Corrugated bellows
1’ Folding bellows
2, 5 Facing sides of the bellows
3 Car body
4 Bridge
6 Screw-on frame
7 Roof
8, 9 Side part
10 Floor
11 Inside area
12 Longitudinal side
13 Narrow side
14 Strips of material
15 Fold
16 Sheet material
17 Seam
18 Corrugation
19 End
20 Clamping profile
21 Symmetry plane
22 Leg
23 Reinforcing section
24 Normal section
25 Imaginary line in the longitudinal direction
26 Peak
27 Straight

1. A bellows as gangway protection for a gangway between two car bodies moving together connected to one another in a multi-section vehicle or for a jetway, the bellows comprising:
a roof; and
two side parts arranged facing one another, at least the two side parts each comprising a multiplicity of folds or corrugations formed of a bendable sheet material;
wherein;
each of the multiplicity of folds or corrugations has a narrow side and a longitudinal side;
each of two of the folds or corrugations abutting one another are joined together on their longitudinal sides
at least one of the folds or corrugations has at least one reinforcing section and at least two normal sections, the at least one reinforcing section having a thickness that is greater than a thickness of the at least two normal sections;
the at least one reinforcing section having a narrow side and a longitudinal side, the longitudinal side of the at least one reinforcing section primarily extends in a direction of the longitudinal side of the respective fold or corrugation; and
an extension of the narrow side of the at least one reinforcing section is a maximum of 75% of an extension of the narrow side of the respective fold or corrugation.

2. The bellows according to claim 1, wherein the at least one reinforcing section is in the form of a strip, the longitudinal side of the at least reinforcing section that is made up of the strip that is at least half as long as the longitudinal side of a straight section of the respective fold or corrugation.

3. The bellows according to claim 2, wherein the strip that is as long as the longitudinal side of the straight section of the respective fold or corrugation.

4. The bellows according to claim 1, wherein the thickness of the at least one reinforcing section is at least 1.25x, 1.5x, or 2x the thickness of the corresponding at least two normal sections.

5. The bellows according to claim 1, wherein the extension of the narrow side of the at least one reinforcing section is a maximum of 60%, 50%, or 25% of the extension of the narrow side of the respective fold or corrugation.

6. The bellows according to claim 1, wherein the extension of the narrow side of the at least one reinforcing section is at least 5% or 10% of the extension of the narrow side of the respective fold or corrugation.

7. The bellows according to claim 1, wherein the bellows is a corrugated bellows, with each corrugation running in a cross-section plane parallel to the narrow side in an arc.

8. The bellows according to claim 1, wherein the bellows is a folding bellows, the folds being arranged in a zigzag pattern in a cross-section plane that is parallel to the narrow side.

9. The bellows according to claim 1, wherein at least one of the folds or corrugations has at least two reinforcing sections running along the narrow side of the respective fold or corrugation.

10. The bellows according to claim 9, wherein the at least one of the folds or corrugations has exactly two reinforcing sections running along the narrow side of the respective fold or corrugation.

11. The bellows according to claim 10, wherein the two reinforcing sections are distributed in mirrored symmetry along the narrow side of the respective fold or corrugation.

12. The bellows according to claim 10, wherein the bellows is a corrugated bellows with a multiplicity of corrugations;
wherein the two reinforcing sections cover two imaginary lines running parallel to the longitudinal sides of the respective corrugation and wherein in a section plane running parallel to the narrow side of the respective corrugation the first of the two imaginary lines is at an angle of + 45° related to a mirrored symmetry plane of the respective corrugation and the second of the two imaginary lines is arranged at an angle of - 45° related to the mirrored symmetry plane;
wherein a peak of the angles is given by an intersection between the mirrored symmetry plane and a vertical straight line at the mirrored symmetry plane, so that a circle around the peak intersects the vertical straight line and the mirrored symmetry plane within the bendable sheet material of the respective corrugation; and
wherein the circle is determined in a non-extended and uncompressed state of the respective corrugation.

13. The bellows according to claim 1, wherein the at least one reinforcing section is made up of a strip of material that is applied to the bendable sheet material of the respective fold or corrugation by being glued, sewn or welded on, or the at least one reinforcing section is made up of a thickening of the bendable sheet material of the respective fold or corrugation.

14. The bellows according to claim 13, wherein the strip of material follows a curve of the bendable sheet material of the respective fold or corrugation.

15. The bellows according to claim 13, wherein the strip of material is sewn together with the bendable sheet material of the respective fold or corrugation with two seams, the seams running in a direction parallel to the narrow side of the strip of material and having a distance of at least 5 mm, 7 mm or 10 mm between the seams.

16. The bellows according to claim 1, wherein the at least one reinforcing section is arranged on an inner side of the bellows.

17. The bellows according to claim 1, wherein at least half of the multiplicity of folds or corrugations has at least one reinforcing section.

18. The bellows according to claim 1, wherein each of the folds or corrugations has at least one reinforcing section.

19. A gangway system comprising:
a bellows according to claim 1; and
a bridge.
